(19) United States
(12) Patent Application Publication
(10) Pub. No.: US 2008/0039074 A1
(43) Pub. Date: Feb. 14, 2008

(54) System and process for global dialing using a mobile device

(75) Inventors: Sean Sealey, Vig (DK); Mikael Breinholst, Copenhagen (DK); Jenny Fielding, New York, NY (US)

Correspondence Address: DERGOSITS & NOAH LLP, FOUR EMBARCADERO CENTER, SUITE 1450, SAN FRANCISCO, CA, 94111, US

(73) Assignee: SWITCH-MOBILE INC.

(21) Appl. No.: 11/788,218

(22) Filed: Apr. 18, 2007

Related U.S. Application Data
(60) Provisional application No. 60/808,752, filed on May 26, 2006.

(51) Int. Cl. H04Q 7/20

(52) U.S. Cl. 455/426.2

(57) ABSTRACT

The present invention integrates a large selection of calling card-like features into one user friendly package. What is disclosed is a system and process for enabling PSTN-network enabled mobile communication devices to connect to international, domestic and Internet-based parties. The present invention permits voice calls all over the globe, and it takes advantage of the growing Internet-based voice communication protocols, including instant messaging services and voice over Internet protocol services. The present invention integrates with or can operate independent of the mobile device's pre-existing contact directory. The present invention can also automate voice connections between mobile phone users and VoIP-enabled messaging clients. By creating and implementing a novel software application on the mobile communication device that automates user authentication, billing and connection to other parties, the present invention provides a low-cost high-technology alternative to pre-existing wireless telephony services.

### RELATED APPLICATION DATA

This nonprovisional utility patent application claims priority under 35 U.S.C. § 119(e)(1) to provisional patent application No. 60/808,752, filed on May 26, 2006.

### TECHNICAL FIELD

The present invention relates generally to communications from mobile devices. Specifically, the present invention discloses a process and system for routing voice calls from a mobile device accessing a PSTN network via the Internet to domestic, international or Internet-based destinations. Also disclosed is a system and process for connecting at least two users who both authorize the call using a gateway computer that verifies the receiving user's availability to take the incoming call.

### BACKGROUND OF THE INVENTION

Mobile devices are rapidly becoming the telecommunication device of choice for all consumers. Cellular and data networks have improved significantly within the last few years, such that many consumers are using mobile communication devices, like cell phones, smartphones and call-enabled personal data assistants, as both their primary contact and communications device. In response to growing reliability on these devices, mobile device manufacturers have added numerous features and options to their products. Such features include better service, added network bandwidth, and the ability to use the mobile device as a voice, wireless network, multimedia and instant messaging client. Additionally, mobile network service providers have implemented many different types of rate plans in order to gather revenue on these many different features.

In spite of recent advances, international phone calls to and from mobile devices are still prohibitively expensive. Call quality is not as reliable as in-network calls, and as a result, most consumers still keep a landline telephone associated with a landline telephone account to make low-cost international and long-distance phone calls. Additionally, mobile devices do not currently take advantage of combining voice capabilities with simultaneous data capabilities—recent instant messaging developments that enable voice chat with online members have not yet been fully implemented on mobile devices.

While many cellular and mobile communication devices use text-based instant messaging services, the ease of using these networks to support voice calls has not been explored as much. In the international market, voice over Internet protocol services have sometimes grown faster than regular telephone services. However, present technology only permits a mobile communication device user to call parties with access to a phone number, which, in spite of current developments, is not always feasible.

What is needed is a system that enables a third party to connect existing wireless customers to international and domestic call destinations in the most economical way. This system would combine existing technology with a virtual calling card service to ensure low-cost voice communication between domestic and international parties. What is needed is a system that facilitates communication between telephone line and internet-based parties. The process to implement this system must be automatic and easy to use.

### SUMMARY OF THE INVENTION

The disclosed invention enables users to apply the low-cost advantages of a calling card service to the ease of using a mobile communication device. While calling card technology is well known, an automated single-/few-click process and apparatus to use such technology is novel. Current implementations are crude and require a lot of manual actions. Conversely, the present invention saves the user a lot of time, since many of the current time-consuming, manual processes involved in setting up a call with a calling card provider are automated.

The present invention utilizes a virtual calling card model, but replaces physical calling cards with a software application module that resides on the user's mobile communication device. The calling card model is well-known in the industry. The calling card industry already offers products that require a user to first dial a gateway number to connect to the calling card provider gateway, wait for an answer tone, and then the user dials the destination number. In order to validate the call and debit the appropriate account, the calling card model prompts entry of a calling card account number and sometimes a personal identification number (PIN) before connecting the user to the destination number. The present invention removes the tediousness of juggling lengthy calling card account numbers while enabling the low-cost features of the calling card service.

To implement the virtual calling card feature of the present invention, a user installs a software application on to his or her mobile communication device. In the preferred embodiment, the present invention is a software application developed in J2ME (Java) that works on a wide variety of mobile communication devices. The software application works as a secondary phone directory, separate from the mobile communication device's main or primary phone directory, where contacts can be stored. Additionally, the software application has the ability to detect what kind of mobile device is being used, and will be able to utilize appropriate portions of the program code to successfully implement the present invention. In one embodiment, the software application portion of the present invention integrates with the mobile communication device's existing features and is able to understand and use such features as the device's post-dial commands and the like.

After registration with the virtual calling card service and successfully installing the exemplary software application on the mobile communication device, the mobile communication device will be able to connect to selected contacts in the present invention by using the mobile device's calling features, post-dial features and exemplary voice over internet protocol (VoIP) servers. Whenever the user wants to make a phone call using the present invention, he starts the application, selects the contact to call, and presses “call.” One will appreciate that other tactile or virtual buttons can be substituted to perform the same function as the “call” button. Once the button is activated, the present invention will automatically connect the mobile device to a predetermined phone number that resides in the software application. In one embodiment of the present invention, the predetermined phone number connects to a VoIP gateway, which transfers the call from the PSTN network to an IP network. The VoIP gateway connects to a softswitch, which queries an application Server to authenticate the identity and account information for the mobile device, as well as confirms whether or not the user has enough funds in his account to pay for the requested call. If the mobile communication device and the user are successfully verified, the softswitch automatically passes the call to a global termination partner for worldwide termination of the phone call. The call is now connected to the destination phone number, charging the user for time spent on the call. The process from contact selection to contact connection is accomplished with very few clicks by the user. All steps from selection to connection are automated and seamless, without any additional intervention by the user.

Additionally, the present invention enables callback to the user's device. The initial call request is made via a HTML GET or POST request, using the mobile communication device's data connection rather than the PSTN network. When the gateway receives the request for a callback, the user account is verified. Once there is verification that the user has an account with the virtual calling card service provider, and that there are enough funds to initiate the call, the present invention calls both the user and the desired contact, and then bridges the call. As with the previous feature, this feature is automatic and initiated with just a few clicks on a desired contact's contact information.

Finally, the present invention also allows a call to be set up by first communicating to the server via a HTML GET or POST request, informing the system that a call is going to be made, after which the mobile handset makes a direct call to the gateway. The gateway already knows where the call is being made to, and can connect the calling party with the receiving party immediately, without requiring any post dial functions on the handset.

The present invention is flexible enough to utilize anonymous dialing features as well. The calls are anonymous because they can be made using arbitrary account numbers or names, rather than traditional phone numbers. The present invention can create a list of available contacts within the installed software application on the mobile communication device, and can regularly update the presence or availability of the contacts. The present invention can connect with any party that has an internet connection to a voice-enabled communication system, including other internet protocol enabled phones and computers.

### BRIEF DESCRIPTION OF THE FIGURES

The present invention is illustrated by way of example and not limitation in the Figures of the accompanying drawings, in which like references indicate similar elements, and in which:

FIG. 1(a) depicts a logical operation flow for the present invention, according to one embodiment of the present invention.

FIG. 1(b) shows a logical operation flow for the call back feature of the present invention, according to one embodiment of the present invention.

FIG. 1(c) shows a logical operation flow for calling via the HTTP Request feature of the present invention, according to one embodiment of the present invention.

FIG. 2 depicts a logical operation flow for calling card prior art.

FIG. 3 is a block diagram illustrating use of the present invention to establish a connection with a contact using an Internet connection, according to one embodiment of the present invention.

FIG. 4 illustrates contact information fields for a contact stored in the mobile communication device's contact list, according to one embodiment of the present invention.

FIGS. 5(a) through 5(g) illustrate a series of exemplary mobile communication device screen shots of the present invention, according to one embodiment of the present invention.

FIG. 6 is a schematic diagram of the present invention establishing a connection with a network of specific friends who are available to talk, according to one embodiment of the present invention.

### DETAILED DESCRIPTION OF THE INVENTION

A process and system to enable low-cost international and domestic voice calls from a mobile PSTN network-based communications device is disclosed. In the following description, for purposes of explanation, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation. The description of the preferred embodiments is not intended to limit the scope of the claims appended hereto.

Aspects of the present invention may be implemented on one or more computers executing software instructions. According to one embodiment of the present invention, server and client computer systems transmit and receive data over a computer network and/or a wireless, fiber or copper-based telecommunications network. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the CPU may directly support the downloaded instructions. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, nor to any particular source for the instructions executed by the server or client computers. In some instances, the client and server functionality may be implemented on a single computer platform.

Aspects of the present invention can be used in a distributed electronic commerce application that includes a client/server network system that links one or more server computers to one or more client computers, as well as server computers to other server computers and client computers to other client computers. The client and server computers may be implemented as desktop personal computers, workstation computers, mobile computers, portable computing devices, personal digital assistant (PDA) devices, cellular telephones, digital audio or video playback devices, or any other similar type of computing device. For purposes of the following description, the terms “network,” “computer network,” and “online” may be used interchangeably and do not imply a particular network embodiment or topography. In general, any type of network (e.g., LAN, WAN, or Internet) may be used to implement the online or computer networked implementation of the present invention. Similarly, any type of protocol (e.g., HTTP, FTP, ICMP, UDP, WAP, SIP, H.323) may be used to communicate across the network.

In a preferred embodiment, the present invention requires a mobile communication device capable of communication on a Public Switched Telephone Network (PSTN) network via a wireless transceiver and capable of accepting installation of third-party applications. The preferred embodiment also requires the mobile communication device user to register an account and personal information on an Internet website, such as http://www.globedialer.com (which is owned and operated by the assignee of the present invention). The present application is currently being marketed and sold under the name, Globe Dialer™, which is a trademark owned by the assignee of the present invention.

To implement the preferred embodiment of the present invention, a telephone network for global termination of the call is required. The preferred embodiment consists of a Voice over Internet Protocol (VoIP) network, consisting of a softswitch for call control, a VoIP gateway to convert the call from PSTN to VoIP, an application server running different specific applications, and a media server playing back Interactive Voice Response (IVR) messages to users. As referred to herein, a media server is functionally a server that plays back media for users of the system. For example, when a call is momentarily interrupted to tell the caller that there is a certain amount of credits remaining on the account, it is the application server running an application that interrupts the call; however, it is the media server that is playing the audio file. One skilled in the relevant art will appreciate that these servers may be logical, rather than physical, and may exist as a single component, or distributed across multiple components on a network. One skilled in the relevant art will also appreciate that the use or combination of these servers is well known in the art.

According to the preferred embodiment, the VoIP gateway has the capability of converting and bridging a PSTN call to a VoIP network call. In addition, the gateway is capable of utilizing any communications protocol that supports Internet-based voice connections, including SIP or H.323, to communicate between the mobile communications device and the gateway server. The gateway could be a specifically designed software-programmed hardware device, or an add-on card within an existing telecommunication system. On a carrier-class level, a programmable Brooktrout, Inc. (Needham, Mass.) TR2020 VOIP gateway could be utilized. On a PBX-class level, a Dialogic Communications Corporation (Franklin, Tenn.) MultiTech Systems MultiVOIP 800 card mounted within a True Data Technology Inc. (Carlsbad, Calif.) Televantage station or trunk could be utilized, and finally, on an entry class level, one could use a programmable Digium (Huntsville, Ala.) TE411P mounted in a HP ProLiant DL360 server.

The application server verifies the mobile communication device and the calling party account information from a data repository, such as a calling party account database. During operation of the present invention, the application server checks whether the mobile communication device that is attempting access has an account with the virtual calling card service and whether there are sufficient funds in the calling party's account to initiate and complete the desired call.

The softswitch completes the connection to the receiving party. If the calling party is successfully verified, the softswitch will connect the calling party and the receiving party over the IP connection. A softswitch is a software-enabled method of connecting one or more communication end points with each other, the use of which is well known in the art. See, e.g. FRANKLIN D. ORTHMAN, JR., SOFTSWITCH, ARCHITECTURE FOR VOIP (McGraw-Hill Publishing 2003).

Elements of the preferred embodiment of the present invention are encoded within a software application installed on the calling party's mobile communication device. While the preferred embodiment is a Java-coded software application, one skilled in the relevant art will appreciate that other programming languages such as BREW, C++, or Symbian may also be used to implement the present invention and its features. Additionally, this application may also be used on a variety of mobile platforms, including Linux, PalmOS, Windows CE, Windows Mobile OS, Mac OS X, Research in Motion, Good Technology, Symbian and more. Use of the present invention requires that the calling party download and install the software application onto the mobile communications device. The software application is retrieved once the calling party registers with the service on the Internet website. One skilled in the relevant art will appreciate that registering with the present invention's service can be accomplished wirelessly or through a direct connection or through an automated transmission to the mobile communications device itself. One will also appreciate that registering with the service can also be performed by the mobile communication device's pre-existing wireless service provider.

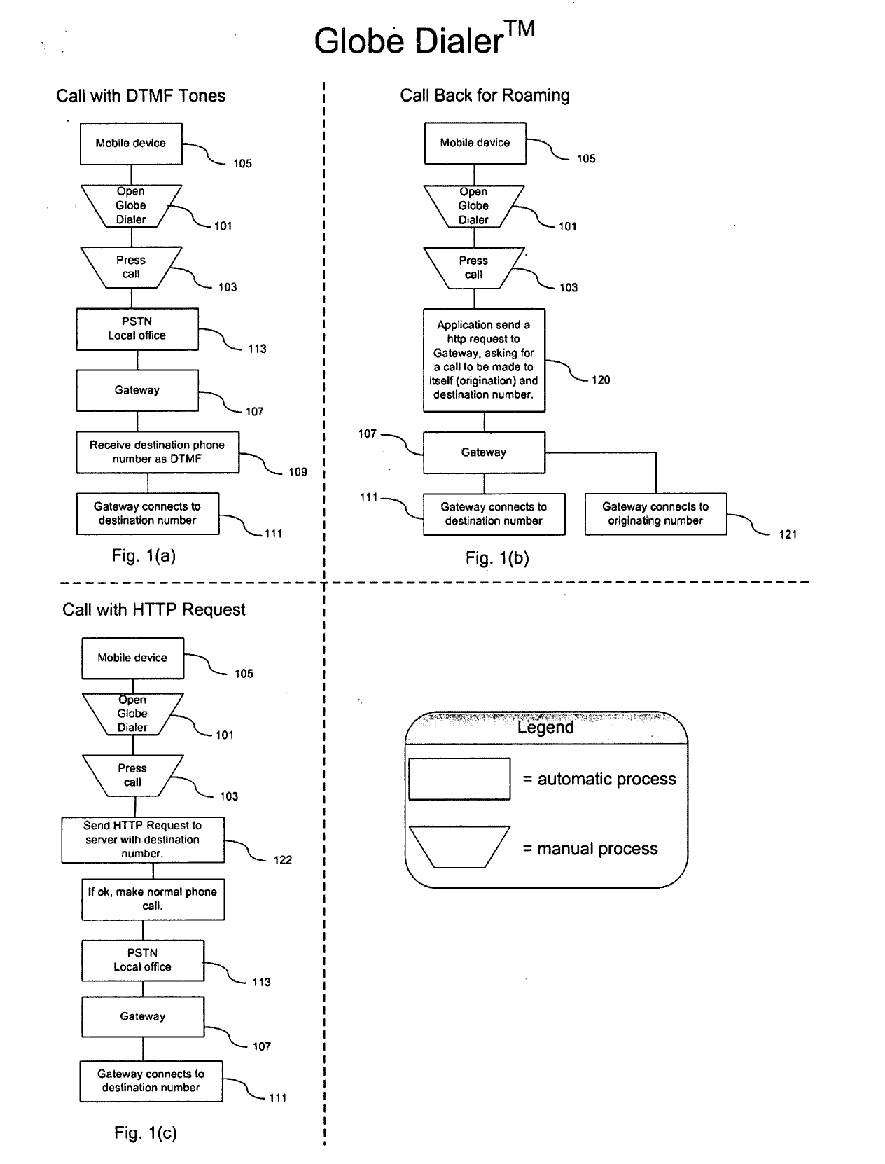

The preferred embodiment is illustrated in the accompanying drawings. FIG. 1(a) is a logical operation flow that illustrates the steps taken by the present invention, according to this embodiment. In a first step, the user, or “calling party,” activates the software application 101 on mobile device 105. The software application 101 will bring up a contact list with contact information for each of those contacts. In one embodiment, this list is created by the user either directly on the mobile communication device 105, or by adding information on the registration website. In another embodiment, this list is a copy of the pre-existing contact list present on many mobile communication devices, and the present invention integrates and enhances the pre-existing contact list to enable the present invention's functionality.

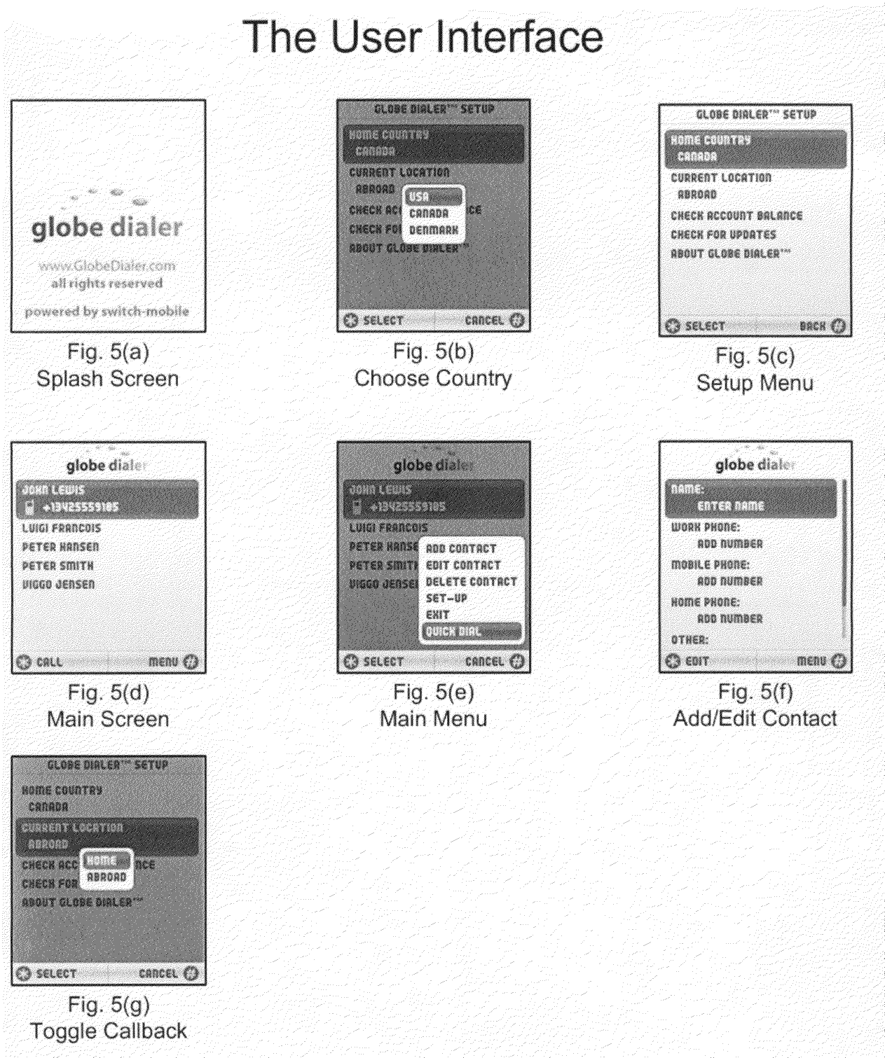

To make a call, the user locates the desired contact in the contact list. According to one embodiment of the present invention, a contact may have more than one contact number, which may be formatted as a traditional phone number, or may be an account number or other alpha-numeric identifier. The user chooses a desired contact number and presses call 103 (See also FIG. 5(d)). This single click executes the automated steps unique to the present invention. Depending on the mobile device, a notification message might be presented to the user stating that a call is being set up, which the user accepts. Once initiated, the present invention causes the mobile communication device 105 to establish a PSTN connection with the gateway 107 through the PSTN Local Office 113. When a connection has been established with the gateway server 107, the application server is queried to identify the identity and account information of the user making the phone call to decide whether the phone call should be allowed or not (not pictured).

At around the same time, the present invention causes the mobile device 105 to start transmitting, over the PSTN network, DTMF tones corresponding to the destination phone number the user is dialing (step 109 of FIG. 1). As noted previously, the gateway 107 is responsible for converting the PSTN connection from the mobile device 105 to an Internet-based connection. A successful call will result in a connection between the mobile device 105 and destination number 111.

According to the preferred embodiment, the application server is also tasked with ensuring that the account associated with the mobile device 105 has sufficient funds to complete the requested call. This is done by automatically checking the destination of the phone call against a database of rates for such calls. If the rate for the call exceeds the amount of available funds in the user's account, then the present invention will notify the user either verbally or through a text message or other similar notification. In one embodiment, the user will have the option of adding funds to the account or postponing the call until more funds are actually in the account.

If calling party authentication is successful, the gateway converts the PSTN signal to VoIP and forwards the call request to the softswitch, including the final destination number. The softswitch receives the desired destination number to connect to, and establishes a connection to the destination contact number 111 through global peering partners. One skilled in the relevant art will appreciate that the destination number can be a wireless or fixed subscriber on the PSTN, a VoIP customer or any other subscriber with a working phone number. One will also appreciate that the telephone signal can be transmitted via VOIP (SIP or H.323) or via normal TDM Inter-Carrier phone lines. Alternatively, as noted previously, the destination number can be an account number set up to contact other parties who are available to communicate over voice over instant messenger or other non-phone number voice-enabled protocols. The format of the signal is not important for the present invention.

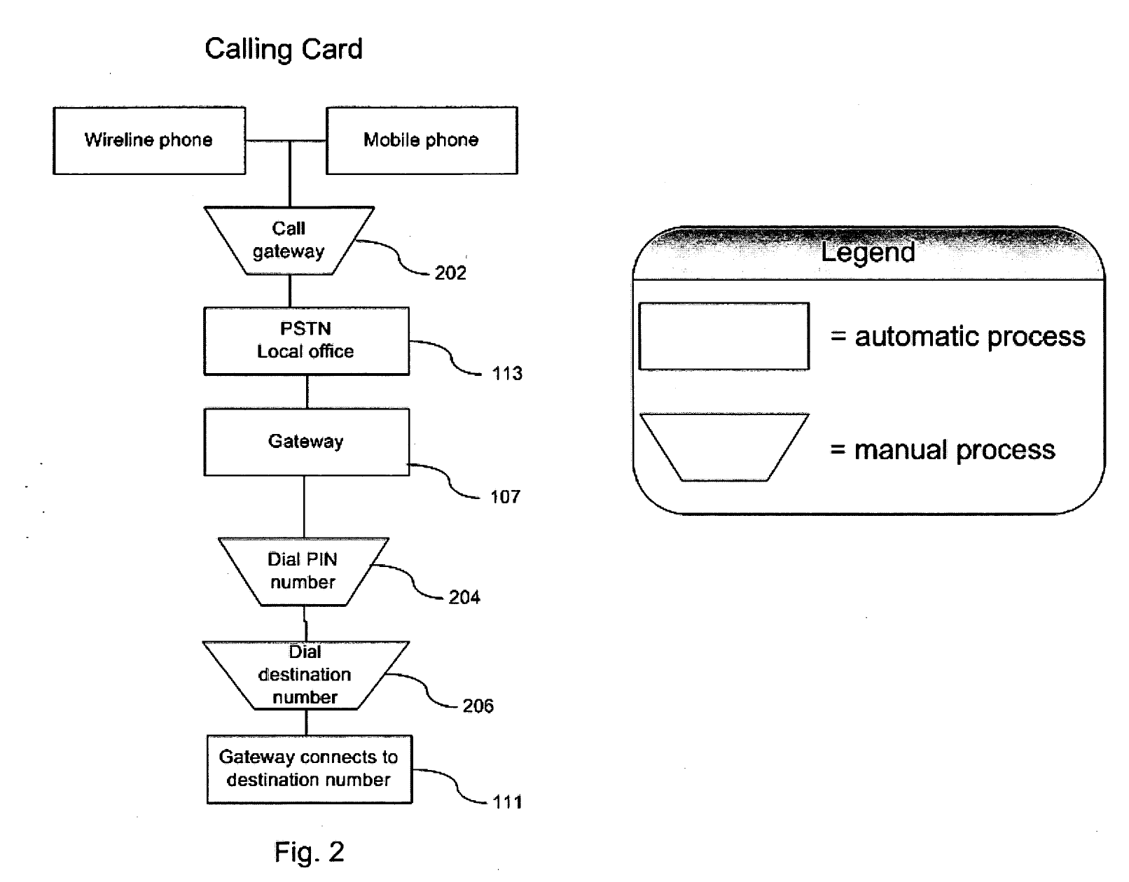

FIG. 2 is a logical operational flow that illustrates how a call is normally set up with a prior art calling card service. In this prior art example, the telephone could be any type of conventional rotary or push-button phone. The same basic principles apply to a wireless phone that connects to a PSTN network through a cellular receiver/transmitter station (not shown). When using a calling card, the customer first manually has to dial the gateway number 202 to connect with gateway 107 over the PSTN network 113. The calling party is now presented with a request 204 to dial the PIN number of the calling card. This operates to authenticate the user, and ensures the associated calling card account has sufficient funds to complete the requested call. Following successful verification, the desired destination number is dialed 206 and the gateway connects to the destination number 111.

There are a number of key differences between the prior art calling card and the present invention. With the present invention, most of the chores of using a calling card are automated, e.g. steps 204 and 206 of FIG. 2. In addition, the use of a mobile communication device with a calling card means that the mobile device's built-in contact list cannot be used, since the calling card generally locks down the mobile device for the duration of the call. This requires memorization of up to 18 digits besides the calling card dial-in number and PIN number, which is the maximum length of a phone number according to the E.164 standard implemented by the ITU (International Telephone Union). It is clear that calling card technology is ill-suited for today's mobile device user who is increasingly relying on saved data on his mobile communication device.

In a preferred embodiment, the present invention also enables callback to the user's mobile communication device, as depicted in FIG. 1(b). In order to activate the present invention's automatic callback function, the user uses the installed software application to change the user's Current Location to Abroad (see also FIG. 5(g)). When the software application is set to Abroad, the present invention will permit the mobile device 105 make calls via a HTTP request over the mobile device's data connection, instead of calling into the VoIP gateway 107 over the PSTN network. In order to initiate the callback, the user first activates the application 101, locates the contact he wants to call, and selects the correct phone or account number and presses call button 103 (see also FIG. 5(d)). The software application will establish an internet connection on the mobile communication device and will send a HTTP request over the internet protocol network 120 with details of the destination phone number and the subscriber setting up the call. The softswitch then calls both the destination number 111 and the subscriber number 121, and then bridges the calls to enable mutual voice communication. During this call, the user will be charged for both calls: one for the call to the destination number, and once more for the call that is set up to the subscriber. One skilled in the relevant art will appreciate that other billing and debiting structures can also apply to this and other previously-described embodiments.

In another embodiment, the present invention sets up the phone call by first establishing a HTTP request over the internet protocol network to the application server 122, depicted in FIG. 1(c). In this embodiment, the HTTP request informs the server who is making the call and where the call is being made to. Once the mobile device 105 has opened up the present invention software application 101 and selected a contact to call 103, this embodiment of the present invention connects to the application server 122. The application server 122 then sends an acknowledgment back to the mobile application. The mobile application then makes a call to the gateway 107 via the PSTN network 113. As soon as the gateway/application server 107 has recognized and correlated the calling party with the user who made the HTTP request, the PSTN call is converted to VoIP and connected to the receiving party 111. One skilled in the relevant art will appreciate that no post dial functions are necessary when setting up a long distance phone call this way.

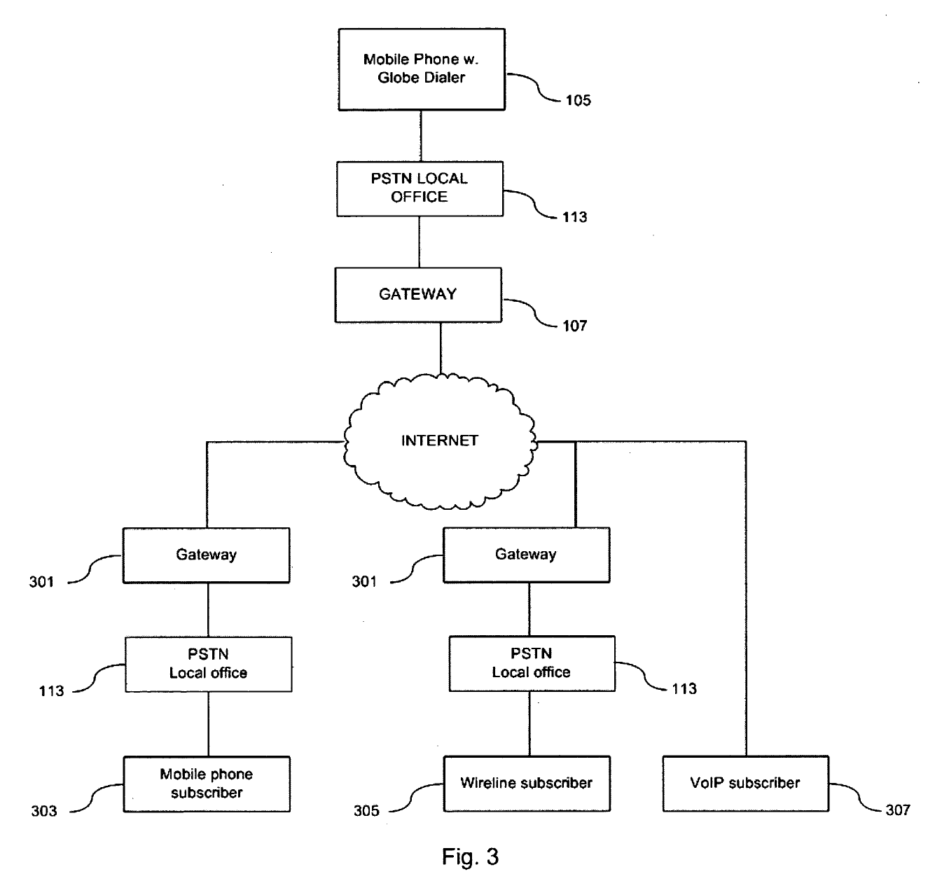

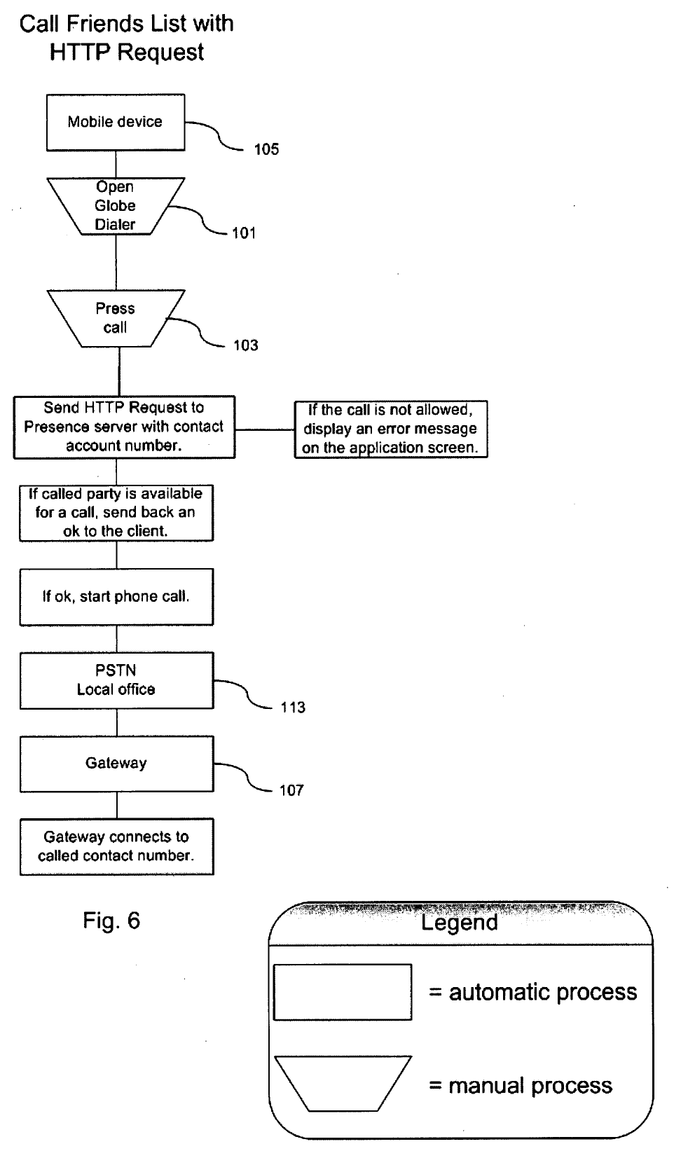

FIG. 3 shows a block diagram in which the present invention utilizes another function of the softswitch setup to initiate voice communication over a VoIP or TDM network. According to this embodiment, the destination being called is either a mobile phone, wireline or VoIP subscriber. The process followed to complete these connections is similar to the other previously-described processes. The flexibility of the present invention and the versatility of the softswitch permits voice communications over a number of different protocols. For example, in another embodiment, the present invention permits voice communication with contacts without using traditional telephone numbers. FIG. 6 is an exemplary flow diagram of the steps taken by the present invention when implementing this particular embodiment. In such an embodiment, the present invention permits communication with the gateway server such that instead of sending a phone number to connect to, an alphanumeric code identifying the contact is sent instead. Once the code is transmitted, the application server then looks up the code and correlates it with an associated destination phone number or third party instant messaging account that supports VoIP communications.

Turning now to FIG. 6, the present invention is launched as a software application 101 on mobile communication device 105. A list of contacts is presented and the user selects the desired contact and presses call 103. In this embodiment, each contact in the software application is identified by an arbitrary number or name, such as an account number or “handle,” that is different from a phone number. One will appreciate that the contact may already have an alphanumeric code representing their contact information, such as an instant messenger handle or similar account name accessible by the present invention's software application. The preferred embodiment of this version of the software synchronizes its list of available contacts with a third party messaging client, such as the open source Jabber client (http://www.jabber.com). Additionally, this embodiment also permits a contact's availability and status to appear, commonly known in the art as “presence.” In one embodiment, a contact that is available to accept a voice call from the user will be specially labeled with an icon, color or “available” label. The present invention has the capability of regularly making data calls to the server to confirm the presence of a contact. Whenever a user wants to call an “available” contact in the phonebook, the user selects the contact and presses the call button 103. The present invention then automatically causes the software application to connect to the gateway and send the numeric handle of the person being called. Verification is then performed in the contact database by the application server, running a specially-written program that requires performance of three steps: first, the handle is used to find the registered phone number of the person being called; second, the system checks whether the person making the call is verified to make the call, wherein the person making the call in the receiver's friend or buddy list; and finally, the system verifies that the receiving party wants to receive calls rather than setting status to “do not disturb,” or something to that effect. If the verification successfully passes all three checks, the softswitch 107 connects to the receiving party over the PSTN network 113 and completes the second leg of the call. One will appreciate that this added embodiment of the present invention does not require installation of additional hardware components. The prior embodiments disclosed herein all retain this added functionality.

Other aspects of the present invention add additional features and benefits to enhance the utility of the present invention. In one embodiment, installation of the present invention's software application creates a secondary phonebook on the mobile device for the user's contact information list. This creates a contact list that is separate from the mobile device's previous phone book. Another embodiment automatically synchronizes the user's contact list with the primary contact list on the mobile device, so entering new contacts is unnecessary.

Another feature of the present invention's software application takes advantage of the specific post-dial features already present in the mobile communication device. Post-dial features are actions available to the device after the first call has been set up. For example, in one embodiment the device will permit transmission of a secondary phone number via DTMF, similar to a calling card feature, without requiring disconnection of the device from the phone call and repeating the initiation step. One will appreciate that different device manufacturers have different ways of implementing post-dial features. Handsets manufactured and sold by Sony Ericsson use the operator “;postd=” to send a secondary batch of numbers as DTMF, while Motorola and some others use the operator “p”.

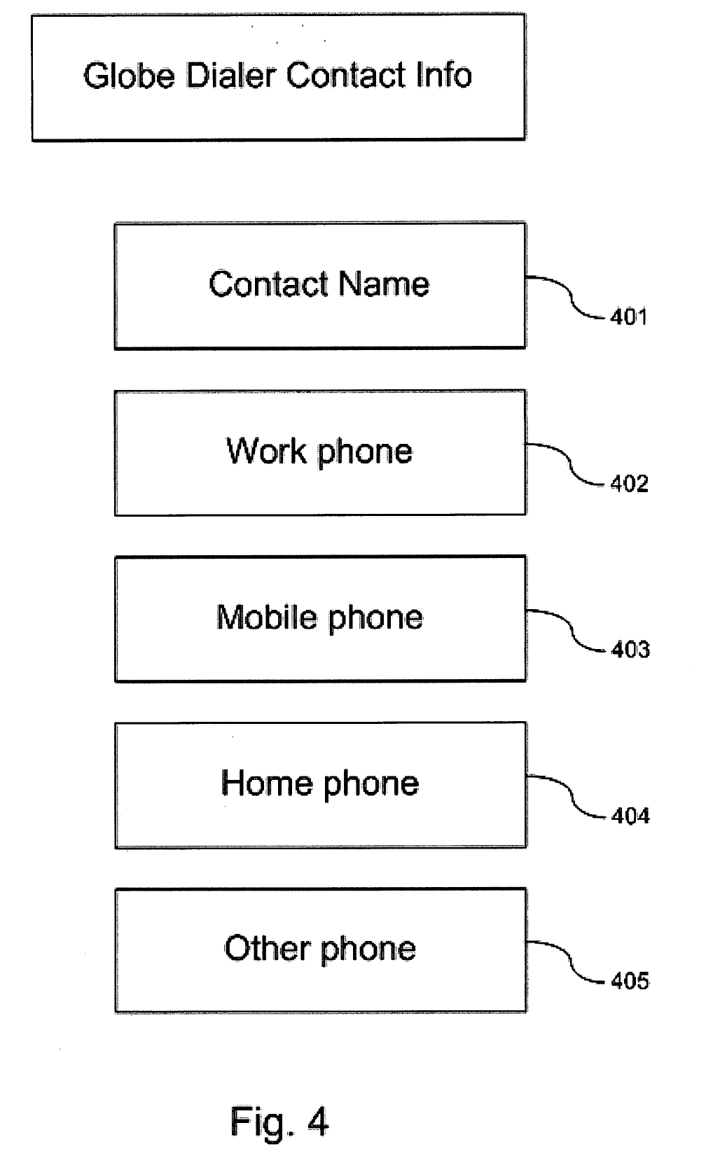

One will appreciate that the present invention's phonebook can provide multiple functions and options to the user. The various fields available in this phonebook are depicted in FIG. 4. In one embodiment, a contact name 401 can have many phone and/or account numbers. The amount of contact information available for storage in the secondary phone book is limited only by the memory of the mobile device. The phonebook interface can be designed to maximize screen space on smaller mobile devices, as well as provide an aesthetic point of interaction to the user (see FIG. 5(f)). FIG. 4 illustrates the possible contact information fields that can be associated with a contact, according to this embodiment. Such fields include Contact Name 401, Work Phone Number 402, Mobile Phone Number 403, Home Phone Number 404 and Other Phone Number 405. One skilled in the art will appreciate that more or less fields can be displayed depending on the limitations of the mobile communication device or the available information for a particular contact.

FIG. 5 illustrates various screenshots of the present invention. A user with the present invention on their mobile communication device might be presented with the graphical user interfaces in FIG. 5. FIG. 5(a) is the introductory splash screen that greets the user upon execution of the installed software, according to one embodiment of the present invention. The present invention is designed to work in a number of different locales, so long as the user has access to a PSTN and/or mobile IP network. FIG. 5(b) shows how the user can designate where his present location is. Further user account information may also be accessed from the mobile communication device, as shown in FIG. 5(c). Once the user has stored contacts in the phonebook of the present invention, those contacts will be presented in the main interface screen, as shown in FIG. 5(d). Contacts can subsequently be edited or deleted, as shown in FIG. 5(e). FIG. 5(f) is an exemplary screenshot of the various fields that can be populated with contact information, as described in FIG. 4. Finally, the callback function of the present invention is enabled by changing the location of the user, as shown in FIG. 5(g) and further depicted in FIG. 1(b).

In the preferred embodiment, the present invention determines the type of mobile communication device it is being installed on. This may be done by looking up device's HTTP User Agent when it accesses the download web page. The HTTP User Agent is used to determine which post-dial feature is available for use by the specific device while setting up a call. This permits the present invention to be applied and implemented across multiple device manufacturer specifications with little to no loss of functionality.

Similarly, the preferred embodiment will automatically change the size of the screen fonts, depending on the screen size of the mobile device. In one embodiment, screens less than 176 pixels wide will have a medium font, whereas screens that are 176 pixels or more show a large font size. The font size is defined in the programming language.

Although embodiments of the present invention have been described with reference to a network implementation comprising the internet and internet-related web browsing and web serving technologies, it should be noted that alternative embodiments of the present invention can be implemented on many other types of networks and network protocols, such as proprietary protocols for local area networks, wide area networks, and any combination thereof.

Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than restrictive sense.

What is claimed is:

1. A process for providing a virtual internet protocol telephone calling card service to a calling party using a wireless public switched telephone network (PSTN) enabled mobile communication device comprising the steps of:
(a) initiating a wireless telephone connection over the PSTN network by selecting a receiving party contact number from a software module containing contact information for the receiving party, the software module installed on the mobile communication device;
(b) automatically establishing, by the software module, a concurrent wireless telephone connection between the mobile communication device and a gateway over the PSTN network;
(c) automatically authenticating the calling party by accessing an application server, the application server containing a database of calling party identities and associated calling party account information;
(d) verifying, by the application server, that the calling party account has sufficient funds to complete the call to the receiving party;
(e) upon successful verification, establishing a voice over internet protocol (VoIP) network connection between the gateway and the receiving party; and
(f) connecting the mobile communication device and the receiving party to establish a voice-based connection between the calling party and the receiving party.

2. The process of claim 1, wherein the initiating step comprises selecting a telephone number associated with the receiving party, the telephone number stored in the software application.

3. The process of claim 1, wherein the initiating step comprises selecting an alphanumeric code associated with the receiving party, the alphanumeric code stored in the software application.

4. The process of claim 1, further comprising the step of verifying whether the receiving party is available to accept a connection.

5. The process of claim 3, wherein the connecting step further comprises looking up a receiving party's alphanumeric code and correlating the alphanumeric code to a phone number for the receiving party.

6. The process of claim 3, wherein the connecting step further comprises looking up a receiving party's alphanumeric code and correlating the alphanumeric code to the receiving party's VoIP-enabled messaging client.

7. The process of claim 1, further comprising the steps of:
(a) recording the amount of time that the calling party is connected to the receiving party;
(b) correlating the connection time to a price rate;
(c) calculating a total cost of the call; and
(d) deducting the cost of the call from the calling party's account.

8. A process for providing a virtual internet protocol telephone calling card service for receiving phone calls by a calling party using a wireless internet enabled mobile communication device comprising the steps of:
(a) enabling a data call on a software module installed on the mobile communication device;
(b) initiating a wireless HTTP connection over an internet protocol network by selecting a receiving party contact number from a software module containing contact information for the receiving party, the software module installed on the mobile communication device;
(c) automatically establishing, by the software module, a wireless data connection between the mobile communication device and a gateway over the internet protocol network;
(d) automatically transmitting a request for verification to an authentication server, the request containing account information for the mobile communication device and the receiving party's contact information;
(e) verifying, by the authentication server, that the account has sufficient funds to complete the call to the receiving party;
(f) upon successful verification, establishing a VoIP network connection between the gateway server and the receiving party;
(g) upon successful verification, establishing a VoIP network connection between the gateway server and the mobile communication device; and
(h) connecting the mobile communication device and the receiving party to establish a voice-based connection between the calling party and the receiving party.

9. The process of claim 8, wherein the initiating step comprises selecting a telephone number associated with the receiving party, the telephone number stored in the software application.

10. The process of claim 8, wherein the initiating step comprises selecting an alphanumeric code associated with the receiving party, the alphanumeric code stored in the software application.

11. The process of claim 8, further comprising the step of verifying whether the receiving party is available to accept a connection.

12. The process of claim 10, wherein the connecting step further comprises looking up a receiving party's alphanumeric code and correlating the alphanumeric code to a phone number for the receiving party.

13. The process of claim 10, wherein the connecting step further comprises looking up a receiving party's alphanumeric code and correlating the alphanumeric code to the receiving party's VoIP-enabled messaging client.

14. The process of claim 10, wherein the connecting step further comprises looking up a receiving party's handle and correlating the handle to the receiving party's VoIP-enabled messaging client.

15. The process of claim 8, further comprising the steps of:
(a) recording the amount of time that the calling party is connected to the receiving party;
(b) correlating the connection time to a price rate;
(c) adding the rate of connecting the receiving party to the calling party;
(d) calculating a total cost of the call; and
(e) deducting the cost of the call from the calling party's account.

16. A process for providing a virtual internet protocol telephone calling card service for receiving phone calls by a calling party using a wireless internet enabled mobile communication device, comprising the steps of:
(a) enabling a data call on a software module installed on the mobile communication device;
(b) initiating a wireless HTTP connection over an internet protocol network by selecting a receiving party contact number from a software module containing contact information for the receiving party, the software module installed on the mobile communication device;
(c) automatically establishing, by the software module, a wireless data connection between the mobile communication device and a gateway over the internet protocol network;
(d) automatically transmitting a request for verification to an authentication server, the request containing account and user information for the mobile communication device and the receiving party's contact information;
(e) verifying, by the authentication server, that the account has sufficient funds to complete the call to the receiving party;
(f) upon successful verification, establishing a PSTN network connection between the mobile communication device and the server;
(g) verifying, by the authentication server, that the mobile communication device just sent a HTTP request asking to set up a phone call; and
(h) upon successful verification, connecting the mobile communication device and the receiving party to establish a voice call connection between the calling party and the receiving party.

17. The process of claim 16, wherein the initiating step comprises selecting a telephone number associated with the receiving party, the telephone number stored in the software application.

18. The process of claim 16, wherein the initiating step comprises selecting an alphanumeric code associated with the receiving party, the alphanumeric code stored in the software application.

19. The process of claim 16, further comprising the step of verifying whether the receiving party is available to accept a connection.

20. The process of claim 18, wherein the connecting step further comprises looking up a receiving party's alphanumeric code and correlating the alphanumeric code to a phone number for the receiving party.

21. The process of claim 18, wherein the connecting step further comprises looking up a receiving party's alphanumeric code and correlating the alphanumeric code to the receiving party's VoIP-enabled messaging client.

22. The process of claim 16, further comprising the steps of:
(a) recording the amount of time that the calling party is connected to the receiving party;
(b) correlating the connection time to a price rate;
(c) adding the rate of connecting the receiving party to the calling party;
(d) calculating a total cost of the call; and
(e) deducting the cost of the call from the calling party's account.

23. A system for providing a virtual internet protocol telephone calling card service to a calling party using a wireless public switched telephone network (PSTN) enabled mobile communication device comprising:
(a) client mobile communication device capable of making and receiving wireless calls over the PSTN network;
(b) a software application module stored in a memory device associated with the client mobile device, the software module comprising a list of receiving party contacts and receiving party contact information;
(c) a gateway capable of receiving a call from a PSTN network, converting the call to a VoIP call, and then transmitting the call via a softswitch;
(d) an application server connected to the softswitch, the application server capable of receiving and authenticating the calling party's identity and account information for the mobile communication device, and authorizing the softswitch to transmit the call to a VoIP network upon successful authentication;
(e) a calling party user account database stored in a memory device associated with the application server, the database storing calling party identification information and calling party account information; and
(f) a softswitch device connected to the VoIP network, the softswitch device capable of connecting the call between the calling party and the receiving party.
